(19) United States
(12) Patent Application Publication
(10) Pub. No.: US 2006/0215139 A1
(43) Pub. Date: Sep. 28, 2006

(54) Pattern exposure method and apparatus

(75) Inventors: Yoshitada Oshida, Ebina-shi (JP); Yoshitatsu Naito, Ebina-shi (JP); Mituhiro Suzuki, Ebina-shi (JP); Tsuyoshi Yamaguchi, Ebina-shi (JP); Shigenobu Maruyama, Yokohama-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Via Mechanics Ltd., Ebina-shi (JP)

(21) Appl. No.: 11/353,017

(22) Filed: Feb. 14, 2006

(30) Foreign Application Priority Data
Mar. 24, 2005 (JP) 2005-087240

(51) Int. Cl. G03B 27/52

(52) U.S. Cl. 355/55; 359/485

(57) ABSTRACT

A maskless exposure method and a maskless exposure apparatus in which maskless exposure can be performed efficiently with high-directivity illumination light, while the exposure efficiency of solder resist can be improved. Blue-violet semiconductor lasers 12A emitting laser beams 1a with a wavelength of 405 nm and ultraviolet semiconductor lasers 12B emitting laser beams 1b with a wavelength of 375 nm are provided to irradiate a substrate 8 with the laser beams 1a and 1b whose optical axes are made coaxial. In this event, one and the same place on the substrate 8 is irradiated with the laser beams 1a and 1b a plurality of times. Thus, the variation in intensity of the laser beams 1a and 1b is averaged.

### FIELD OF THE INVENTION

The present invention relates to a pattern exposure method and a pattern exposure apparatus in which laser beams are converged on a substrate to be exposed, so as to scan the substrate and draw a pattern, and particularly relates to a pattern exposure method and a pattern exposure apparatus in which a substrate is irradiated with a plurality of laser beams output from a plurality of lasers so as to expose a plurality of portions of the substrate simultaneously.

### DESCRIPTION OF THE BACKGROUND ART

In the background art, for exposing pattern on a printed circuit board, a TFT substrate or a color filter substrate of a liquid crystal display or a substrate of a plasma display (hereinafter referred to as “substrate” simply), a mask serving as a pattern master is produced, and the substrate is exposed with the mask in a mask exposure apparatus.

In recent years, in spite of requiring more large-sized substrates, the time allotted to design and production of these substrates becomes shorter and shorter. When the substrates are designed, it is very difficult to eliminate design errors perfectly. A mask is often produced again on reviewed design. In addition, some kinds of substrates are often produced in a large item small scale production manner. A mask produced for each of many kinds of substrates results in increase of the cost and delay of the date of delivery. Therefore, the request for maskless exposure using no mask has increased.

Of methods for performing maskless exposure, the first method is a method in which a two-dimensional pattern is generated by use of a two-dimensional spatial modulator such as a liquid crystal or a DMD (Digital Mirror Device), and a substrate is exposed to light with the two-dimensional pattern through a projection lens (JP-A-11-320968). According to this method, a comparatively fine pattern can be drawn.

The second method is a method in which a substrate is scanned with a laser beam by use of a high-power laser and a polygon mirror and exposed to the laser beam by use of an EO modulator or an AO modulator. Thus, the substrate is patterned. This method is suitable for drawing a rough pattern over a wide area, and the configuration is so simple that a comparatively low-priced apparatus can be produced.

However, according to the first method, the apparatus cost increases, and the running cost increases.

On the other hand, according to the second method, it is difficult to pattern a large area with high definition. In addition, in order to shorten the throughput, a high-power laser is required. Thus, the apparatus cost increases, and the running cost increases.

In a background-art exposure apparatus using a mask, a mercury lamp is used as a light source. The mercury lamp has an intensive wavelength spectrum distribution in 365 nm (i-line of near-ultraviolet), 405 nm (h-line of violet) and 436 nm (g-line). Therefore, a photo-resist to be used for patterning is made so that good patterning can be performed when the photo-resist is exposed with these wavelengths. Particularly, most photo-resists react to light with a wavelength of 365 nm or 405 nm.

In maskless exposure, it is not impossible to use a mercury lamp as a light source. However, it is difficult to obtain high-directivity exposure illumination light efficiently from the mercy lamp.

Printed circuit boards need a process for exposing a solder resist. The sensitivity of the solder resist is generally low, and the throughput in exposure is low.

### SUMMARY OF THE INVENTION

It is an object of the present invention to provide a maskless exposure method and a maskless exposure apparatus in which maskless exposure can be performed efficiently with high-directivity illumination light. It is another object of the present invention to provide a maskless exposure method and a maskless exposure apparatus in which the exposure efficiency of solder resist can be improved.

In order to attain the foregoing objects, a first configuration of the present invention is a pattern exposure method for moving outgoing beams emitted from light sources and a work relatively so as to expose a desired position of the work to the outgoing beams, the pattern exposure method including the steps of: preparing a plurality of light sources emitting outgoing beams different in wavelength; and turning on/off the light sources to thereby irradiate one and the same point of the work with a plurality of beams different in wavelength.

A second configuration of the present invention is a pattern exposure apparatus including: at least two color light sources emitting lights different in wavelength; an optical system for projecting outgoing beams emitted from the light sources on a work; a switching means for turning on/off the light sources; a moving means for moving projected spots and the work relatively; and a control means for controlling the relative movement of the projected spots and the work and the on/off switching of the light sources synchronously with each other.

Maskless exposure can be performed efficiently with high-directivity illumination light. In addition, the exposure efficiency of solder resist can be improved.

### BRIEF DESCRIPTION OF THE DRAWINGS

FIG. 1 is a configuration diagram of a maskless exposure apparatus according to a first embodiment of the present invention;

FIGS. 2A-2B are configuration views of a light source optical system according to the present invention;

FIG. 3 is a characteristic graph showing a light transmission characteristic of a wavelength selection beam splitter;

FIG. 4 is a plan view of spots imaged on a substrate;

FIG. 5 is a plan view of spots imaged on a substrate;

FIGS. 6A-6C are views for explaining the layout of blue-violet semiconductor laser beams and ultraviolet semiconductor laser beams;

FIG. 7 is a configuration diagram of a maskless exposure apparatus according to a second embodiment of the present invention;

FIGS. 8A-8B are configuration views of a light source optical system according to the present invention;

FIG. 9 is a configuration diagram of a maskless exposure apparatus according to a third embodiment of the present invention; and

FIG. 10 is a configuration diagram of a maskless exposure apparatus according to a fourth embodiment of the present invention.

### DETAILED DESCRIPTION OF THE INVENTION

The present invention will be described below in detail based on its embodiments and with reference to the drawings.

### First Embodiment

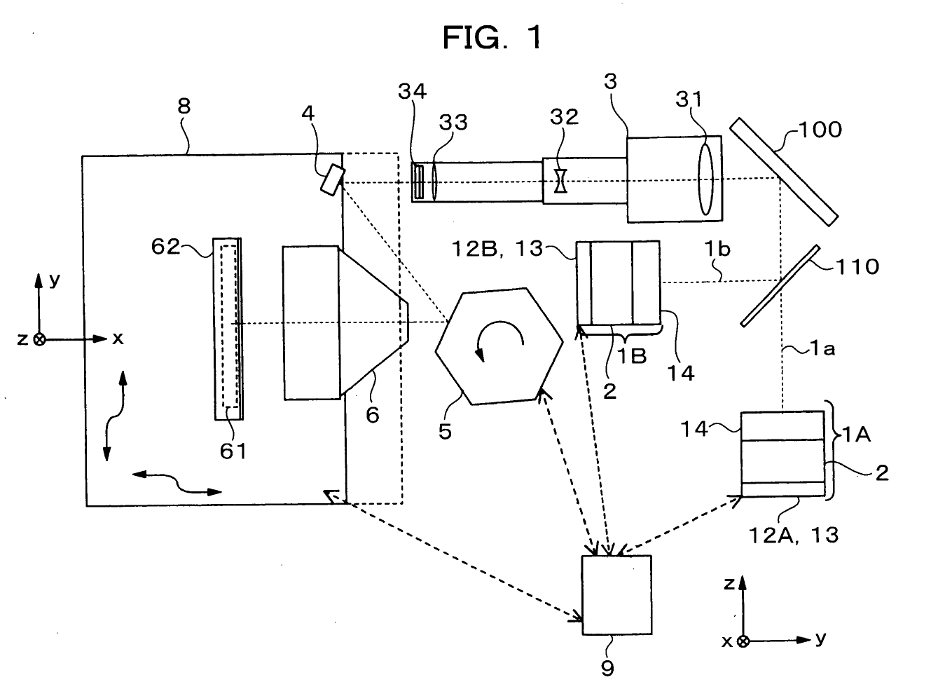

FIG. 1 is a configuration diagram of a maskless exposure apparatus according to a first embodiment of the present invention.

A light source optical system 1A is constituted by a plurality of (128 in this embodiment) blue-violet semiconductor lasers 12A and so on for outputting laser beams with a wavelength of 405 nm. The blue-violet semiconductor lasers 12A output 128 laser beams 1a. There is a variation of 405±7 nm in the wavelength of the laser beams 1a output from the blue-violet semiconductor lasers 12A.

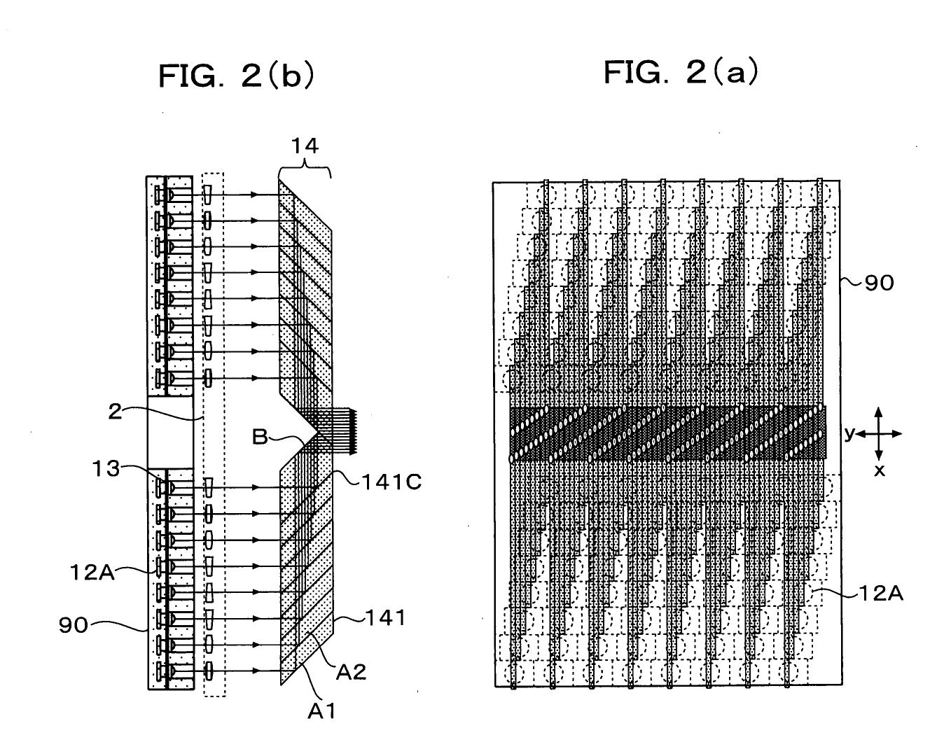

Next, the light source optical system 1A will be described in more detail with reference to FIGS. 2A and 2B.

FIGS. 2A and 2B are configuration views of the light source optical system 1A. FIG. 2A is a view viewed from the traveling direction of the laser beams 1a. FIG. 2B is a view viewed from a direction where the traveling direction of the laser beams 1a is parallel to the paper.

The light source optical system 1A is constituted by 128 blue-violet semiconductor lasers 12A and aspherical lenses 13 disposed and arrayed in two directions. The blue-violet semiconductor lasers 12A are held in a semiconductor laser holder substrate 90.

Each blue-violet semiconductor laser 12A emits a laser beam 1a with a wavelength of 405 nm and an output power of 60 mW. The emitted laser beam 1a is a divergent beam (the full width at half maximum intensity of the angle of x-direction divergence is about 22 degrees, and the full width at half maximum intensity of the angle of y-direction divergence is about 8 degrees, when the x-direction designates the up/down direction and the y-direction designates the left/right direction in FIG. 2A). The laser beam 1a is converged into a collimated beam by the corresponding aspherical lens 13 with a short focal length.

The laser beams 1a emitted from the 128 blue-violet semiconductor lasers 12A have to be formed into collimated beams individually and made parallel with one another. To this end, the aspherical lenses 13 are adjusted by micro-motion in the x-, y- and z-directions by a not-shown fine adjustment mechanism. Each aspherical lens 13 is moved in the optical axis direction so as to make each beam a collimated beam, while each aspherical lens 13 is moved in two directions perpendicular to the optical axis so as to make the beams parallel to one another.

However, all the 128 laser beams 1a cannot be adjusted as collimated beams only by the fine adjustment mechanism of the aspherical lenses 13. Therefore, a wedge glass 2 having a wedge-like shape is provided on the optical axis of each blue-violet semiconductor laser 12A. When laser beams 1a cannot be adjusted as collimated beams, the optical axes of the laser beams 1a are tilted slightly by the corresponding wedge glasses 2 so that all the laser beams 1a are fitted to parallelism within several tens of seconds.

The laser beams 1a made parallel to one another are incident on a without-changing-beam-diameter beam pitch reduction means 14 perpendicularly thereto.

In the without-changing-beam-diameter beam pitch reduction means 14, a plurality of prisms 141 which are parallelograms in section are placed on one another symmetrically with respect to the center of the semiconductor laser holder substrate 90. Incidentally, the central portion of the without-changing-beam-diameter beam pitch reduction means 14 is formed in a so-called nested structure (a shape in which the prisms 141 formed like comb teeth are combined with one another) such that the laser beams 1a are transmitted through only the interiors of the prisms 141.

Pay attention to the laser beam 1a at the bottom in FIG. 2B. Due to the aforementioned configuration, the laser beam 1a reflected by a surface A1 of a prism 141 turns upward. Then, the laser beam 1a reflected by a left end surface B of a prism 141c turns right. The second laser beam 1a from the bottom reflected by a second prism 141 from the bottom turns upward. Then, the laser beam 1a reflected by the left end surface B of the prism 141c turns right.

As a result, when the blue-violet semiconductor lasers 12A are arranged on the semiconductor laser holder substrate 90, for example, with a pitch of 12 mm both in the x-direction and in the y-direction, the laser beams 1a collimated by the aspherical lenses 13 (with an elliptic intensity distribution measuring about 4 mm in x-direction diameter and about 1.5 mm in y-direction diameter) are incident on the without-changing-beam-diameter beam pitch reduction means 14 in the state where the laser beams 1a are arranged with a pitch of 12 mm both in the x-direction and in the y-direction. When the laser beams 1a are transmitted through the without-changing-beam-diameter beam pitch reduction means 14, the laser beams 1a are arranged with a pitch of 1 mm in the x-direction without any change in their beam shapes. That is, as shown in FIG. 2A, the interval between adjacent ones of the blue-violet semiconductor lasers 12A is 12 mm, while the x-direction interval between adjacent ones of the laser beams 1a transmitted through the without-changing-beam-diameter beam pitch reduction means 14 is 1 mm.

A wavelength selection beam splitter 110, a mirror 100, a long focus lens 3, a mirror 4, a polygon mirror 5, an fθ lens 6, a mirror 62 and a cylindrical lens 61 are disposed on the optical axis of each laser beam 1a output from the light source optical system 1A.

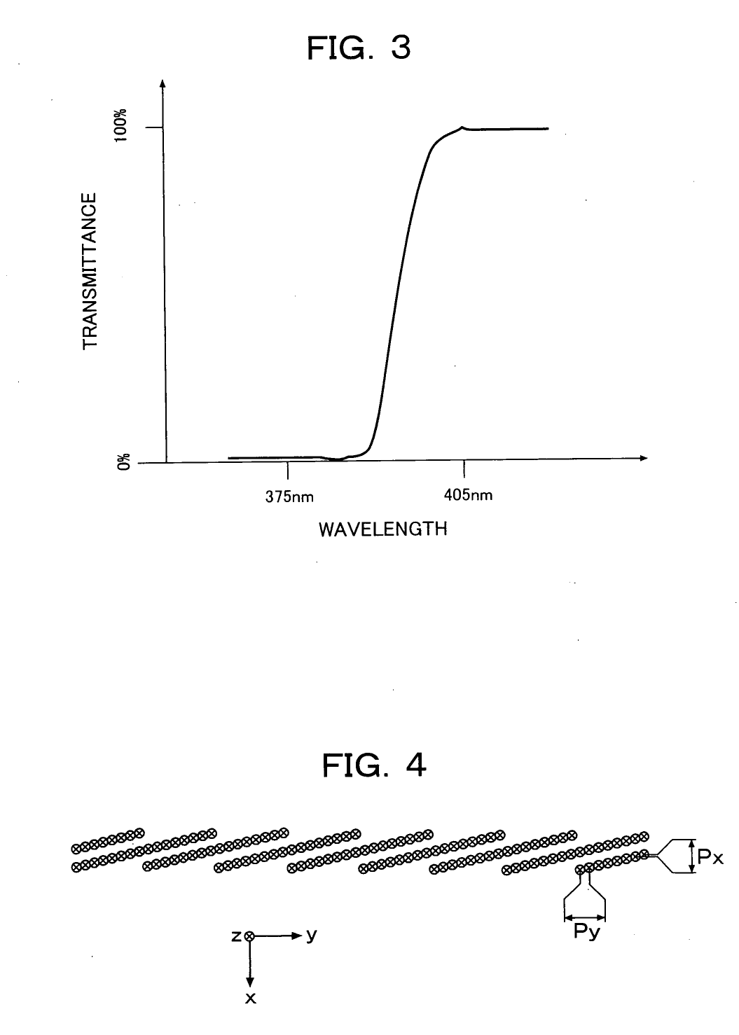

FIG. 3 is a characteristic graph showing the light transmission characteristic of the wavelength selection beam splitter 110. The abscissa designates the wavelength, and the coordinate designates the transmittance. As shown in FIG. 3, the wavelength selection beam splitter 110 transmits almost 100% of light with a wavelength not shorter than 400 nm, and reflects almost 100% of light with a wavelength shorter than 390 nm.

The focal length f of the long focus lens 3 is 20 m, and is constituted by 4 groups of lenses. That is, the spherical system is constituted by a first group 31, a second group 32 and a third group 33, and a fourth group 34 is composed of cylindrical lenses. Only one lens of each group is shown in FIG. 1. Actually each group consists of four or more different lenses made of a glass material in order to correct chromatic aberration and correct aberration such as spherical aberration.

Due to the aforementioned configuration, each laser beam 1a with a wavelength of 405 nm output from the light source optical system 1A passes the wavelength selection beam splitter 110 with little loss, and enters the long focus lens 3 directed by the mirror 100. The laser beam 1a leaving the long focus lens 3 is incident on the fθ lens 6 directed by the mirror 4 and the polygon mirror 5. The laser beam 1a leaving the fθ lens 6 is incident on (irradiates) the substrate 8 directed by the mirror 62 and the cylindrical lens 61.

The configuration of a light source optical system 1B is substantially the same as that of the light source optical system 1A. However, the blue-violet semiconductor lasers 12A are replaced by ultraviolet (UV) semiconductor lasers 12B disposed for outputting laser beams 1b with a wavelength of 375 nm. Then, 128 laser beams 1b parallel to one another and with an x-direction interval of 1 mm are output from the light source optical system 1B. There is a variation of 375±7 nm in the wavelength of the laser beams 1b output from the ultraviolet semiconductor lasers 12B.

The light source optical system 1B is positioned so that the optical axes of the laser beams 1b output therefrom coincide with the optical axes of the laser beams 1a transmitted through the wavelength selection beam splitter 110 respectively.

As a result, the optical axes of the laser beams 1b reflected by the wavelength selection beam splitter 110 with little loss coincide with the optical axes of the laser beams 1a transmitted through the wavelength selection beams splitter 110 respectively. The laser beams 1b are incident on the substrate 8 via the same path as the laser beams 1a.

The control unit 9 controls the on/off of the blue-violet semiconductor lasers 12A and the violet semiconductor lasers 12B, and a not-shown means for moving the polygon mirror 5 and the substrate 8.

Here, description will be made on the size (spot diameter) of each laser beam.

The 128 laser beams 1a and the 128 laser beams 1b transmitted through the long focus lens 3 are collimated beams each having a spread of about 10 mm in the y-direction (scanning direction). Each collimated beam has an angle Δθ with respect to the center of a spot array (coaxial with the optical axis of the long focus lens 3) in accordance with the position of the blue-violet semiconductor laser 12A or the ultraviolet semiconductor laser 12B radiating the beam on the semiconductor laser holder substrate 90 (the angle Δθ is a very small angle)

In the x-direction (sub-scanning direction), the beams are reflected by the mirror 4 and then converged on the polygon mirror 5 by the condensing effect of the convex cylindrical lens 34 in FIG. 1. The positions where the beams are converged are proportional to the x-direction spot positions on the wavelength selection beam splitter 110.

When the y-direction distance between the center of the spot array on the wavelength selection beam splitter 110 and each spot is L, the aforementioned angle Δθ can be expressed by Expression 1 using the focal length f of the long focus lens 3.
Δθ=L/f (Expression 1)

Each laser beam 1a, 1b parallel to the scanning direction (y-direction) on the polygon mirror 5 is converged on the substrate 8 by the fθ lens 6.

There is an imaging relationship between the reflection surface of the polygon mirror 5 and the surface of the substrate through the fθ lens 6 and the cylindrical lens 61. Accordingly, each laser beam 1a, 1b converged in the sub-scanning direction (x-direction) on the polygon mirror 5 is reflected by the polygon mirror 5. After that, the laser beam 1a, 1b transmitted through the fθ lens 6 having a chromatic aberration correction characteristic is converged on the substrate 8 by the condensing effect of the cylindrical lens 61 having a convex lens effect in the x-direction.

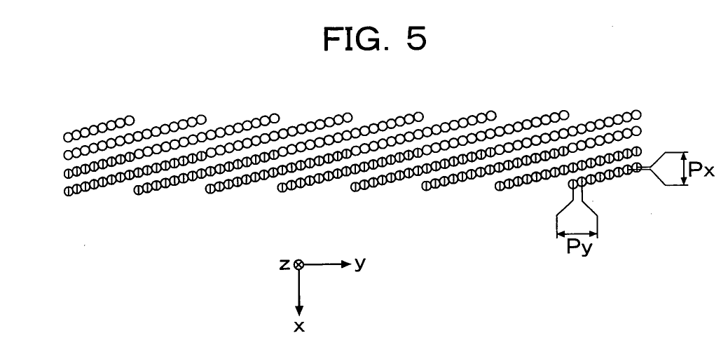

As a result, as shown in FIGS. 4 and 5, multi-spots each having a substantially circular shape with a diameter not longer than several tens of μm are imaged in the illustrated arrays on the substrate 8.

Here, description will be made on the method for disposing the blue-violet semiconductor lasers 12A and the ultraviolet semiconductor lasers 12B.

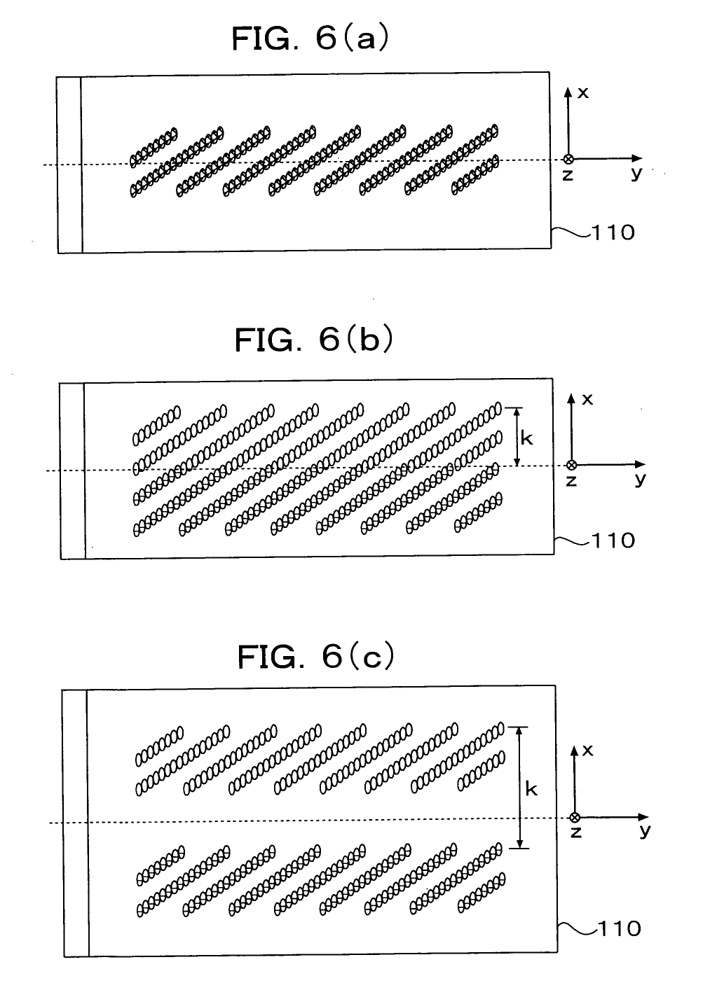

FIGS. 6A-6C are diagrams for explaining the layout of the blue-violet semiconductor lasers 12A and the ultraviolet semiconductor lasers 12B.

In the case of FIG. 1, the optical axes of the laser beams la transmitted through the wavelength selection beam splitter 110 are coaxial with the optical axes of the laser beams 1b reflected by the wavelength selection beam splitter 110 as shown in FIG. 6A.

Accordingly, when all the blue-violet semiconductor lasers 12A and the ultraviolet semiconductor lasers 12B are on (that is, when the blue-violet semiconductor lasers 12A and the ultraviolet semiconductor lasers 12B are turned on/off by one and the same signal), the laser beams 1a and the laser beams 1b are incident on the same places on the substrate 8 respectively.

The x-direction in FIGS. 6A-6C is a sub-scanning direction (direction where the substrate 8 moves), and an array pitch Px of the laser beams 1a is equal to resolution Δ. On the other hand, the y-direction in FIGS. 6A-6C is a scanning direction (scanning direction with the polygon mirror 5), and an array pitch Py is an integral multiple of the resolution Δ of a drawn pattern.

In FIG. 6B, the laser beams 1a and the laser beams 1b are disposed with an x-direction displacement of a distance k from each other on the wavelength selection beam splitter 110. Here, the distance k is equal to the distance with which the substrate 8 moves in the x-direction during one scan with the polygon mirror. Also in this case, the laser beams 1a and the laser beams 1b are radiated on the same places, but exposure with the laser beams 1a is shifted from exposure with the laser beams 1b by one scan cycle of the polygon mirror.

When exposure is performed with such a time lag, there is an effect as follows. That is, exposure light with a short wavelength is absorbed by a photosensitive agent in a high ratio. Therefore, for example, when the thickness of the photosensitive agent is thick, short-wavelength exposure light may be absorbed by the photosensitive agent before reaching a bottom portion. In such a case, exposure with long-wavelength exposure light is performed to expose the photosensitive agent down to its bottom before the surface of the photosensitive agent is exposed with short-wavelength exposure light. In such a manner, the photosensitive agent can be exposed uniformly from its surface to its bottom.

Alternatively, as shown in FIG. 6C, the distance k shown in FIG. 6B may be extended to be n times (n≧2) as large as the distance with which the substrate 8 moves in the x-direction in one scan cycle of the polygon mirror.

Thus, the photosensitive agent can be exposed at optimal timing by use of two or more exposure lights different in wavelength.

For example, when the position of the light source optical system 1A as a whole is moved up or down or when two mirrors are disposed between the light source optical systems 1A and 1B and the wavelength selection beam splitter 110 so that the angles or distances of the mirrors can be adjusted to provide a desired displacement, the array positions of the laser beams with two wavelengths can be made to coincide with each other or shifted from each other as described above.

The intensities of the blue-violet semiconductor lasers 12A and the ultraviolet semiconductor lasers 12B may be adjusted (or turned off in one instance) for each of a plurality of wavelengths so that the intensity ratio of each wavelength can be optimized for the photosensitive agent. Thus, exposure can be accomplished with an optimized spectral intensity ratio.

### Second Embodiment

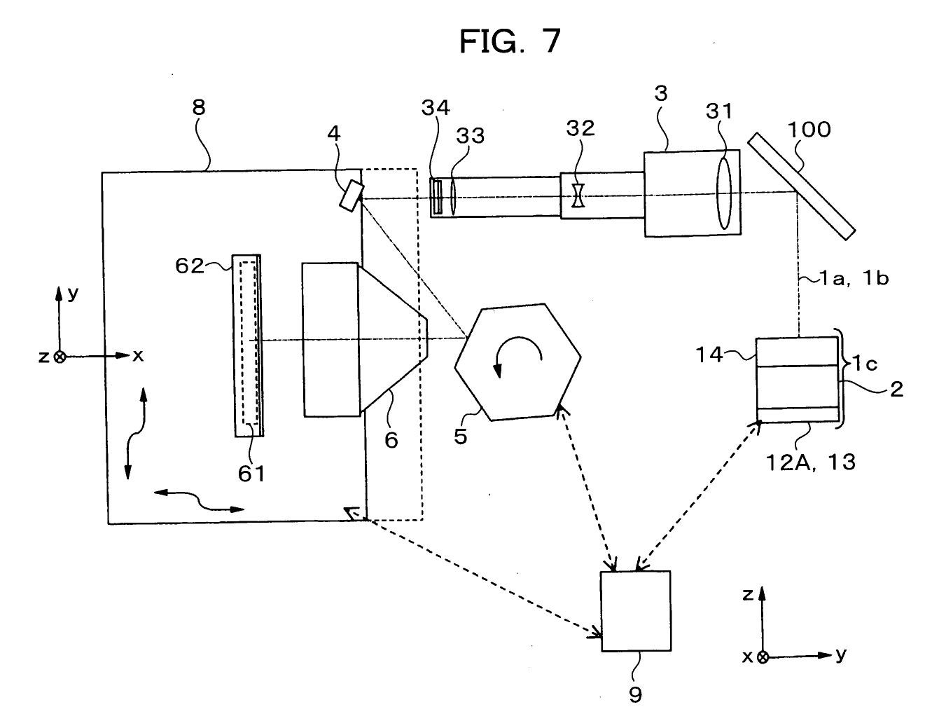

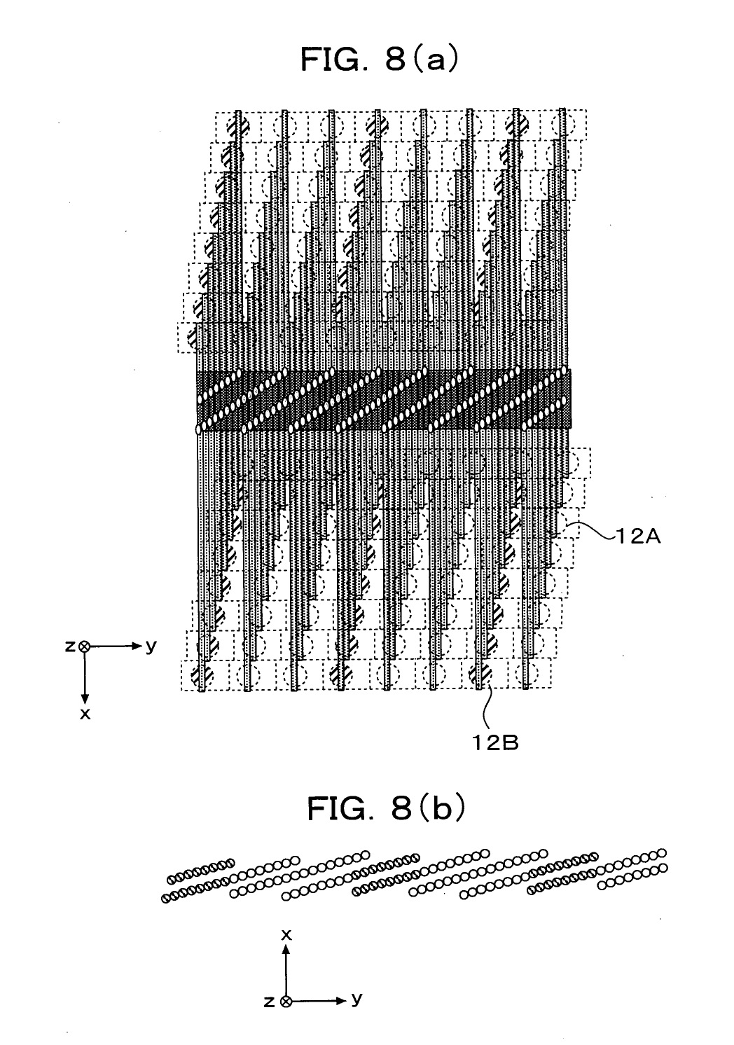

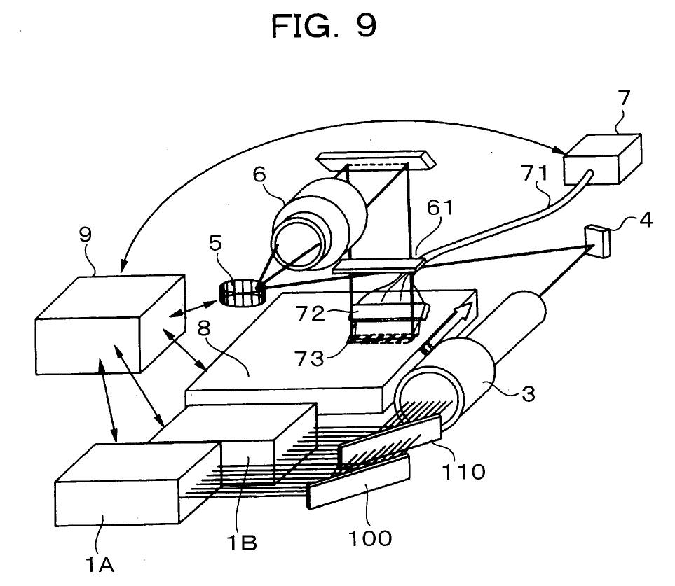

FIG. 7 is a configuration diagram of a maskless exposure apparatus according to a second embodiment of the present invention. FIGS. 8A and 8B are configuration views of a light source optical system 1C. FIG. 8A is a view viewed from a traveling direction of laser beams. FIG. 8B is a view viewed from a direction where the traveling direction of the laser beams is parallel with the paper. Parts the same as or functionally the same as those in FIGS. 1 and 2A-2B are referenced correspondingly, and so the description thereof will be omitted.

In the aforementioned first embodiment, only the blue-violet semiconductor lasers 12A or the ultraviolet semiconductor lasers 12B are held on one semiconductor laser holder substrate 90. In the second embodiment, however, 80 blue-violet semiconductor lasers 12A (designated by the white circles in FIGS. 8A-8B) and 48 ultraviolet semiconductor lasers 12B (designated by the shaded circles in FIGS. 8A-8B) are mixed and held on one semiconductor laser holder substrate 90.

In such a manner, the wavelength selection beam splitter 110 is dispensable so that the apparatus configuration can be simplified.

In the second embodiment, each blue-violet semiconductor laser 12A or each ultraviolet semiconductor laser 12B blinks while scanning in the y-direction. As a result, a desired place of the substrate is exposed to five laser beams 1a and three laser beams 1b.

The ratio between the blue-violet semiconductor lasers 12A and the ultraviolet semiconductor lasers 12B held on one semiconductor laser holder substrate 90 may be determined to be the most suitable to a member to be exposed.

The exposure intensity ratio between the laser beams 1a and the laser beams 1b is determined in a certain range based on conditions such as the spectral sensitivity of the photosensitive agent, the width of an exposure pattern, the thickness of the photosensitive agent, etc. In such a case, it is desired to perform exposure with an optimized exposure intensity ratio depending on the conditions to be used. To this end, it is more effective to determine the number of the blue-violet semiconductor lasers 12A and the number of the ultraviolet semiconductor lasers 12B in advance so as to satisfy optimal ranges of the conditions to be used, and to change the intensity of the blue-violet semiconductor lasers 12A and the intensity of the ultraviolet semiconductor lasers 12B so as to optimize the exposure intensity ratio.

### Third Embodiment 3

FIG. 9 is a configuration diagram of a maskless exposure apparatus according to a third embodiment of the present invention. Parts the same as or functionally the same as those in FIGS. 1 and 2A-2B are referenced correspondingly, and so the description thereof will be omitted.

A high-power infrared semiconductor laser is mounted inside an infrared light source 7. One end of an optical fiber 71 consisting of a bundle of plural fibers is connected to the infrared light source 7. The other end portion 72 of the optical fiber 71 has a configuration in which the plural fibers are arranged to be long laterally (for example, in a single horizontal line). The other end portion 72 is positioned in a position facing a region to be scanned with a polygon mirror 5.

Due to the aforementioned configuration, infrared light emitted from the semiconductor laser inside the infrared light source 7 enters the optical fiber 71 and leaves the optical fiber 71 from the outgoing end surface 72 so as to illuminate the region to be scanned with the polygon mirror 5.

With this configuration, irradiation with infrared light can be performed concurrently with or around irradiation with exposure light for forming a pattern. By the effect of the infrared light, highly photosensitive exposure can be accomplished.

When the position of the outgoing end surface 72 is adjusted, irradiation with the infrared light can be performed after lapse of several deci-seconds or several seconds since exposure.

### Fourth Embodiment

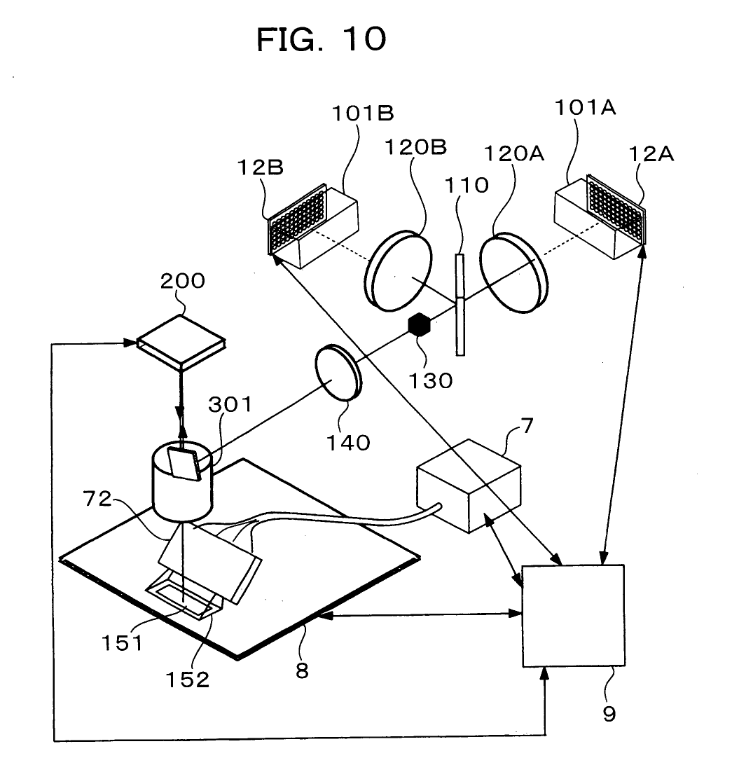

FIG. 10 is a configuration diagram of a maskless exposure apparatus according to a fourth embodiment of the present invention. Parts the same as or functionally the same as those in FIGS. 1 and 2A-2B are referenced correspondingly, and so the description thereof will be omitted.

In the same manner as in the first embodiment, a light source optical system 1A is constituted by a plurality of blue-violet semiconductor lasers 12A disposed in arrays in two directions, and not-shown cylindrical lenses as will be described later. The array direction of the blue-violet semiconductor lasers 12A held on a semiconductor laser holder substrate 90 is different from that in the first embodiment. The blue-violet semiconductor lasers 12A are arrayed on a grid.

In a light source optical system 1B, a plurality of ultraviolet semiconductor lasers 12B are disposed and arrayed in two directions in the same manner as in the first embodiment. However, the array direction of the ultraviolet semiconductor lasers 12B held on the semiconductor laser holder substrate 90 is different from that in the first embodiment. The ultraviolet semiconductor lasers 12B are arrayed on a grid.

An optical system 101A, a condenser lens 120A, a wavelength selection beam splitter 110, an integrator 130, a condenser lens 140, a mirror 301, a DMD 200 and a projection lens 301 are disposed on the optical path of the laser beams 1a output from the blue-violet semiconductor lasers 12A.

An optical system 101B and a condenser lens 120B are disposed on the optical path of the laser beams 1b output from the ultraviolet semiconductor lasers 12B.

In the light source optical systems 101A and 101B, short-focus cylindrical lens arrays and long-focus cylindrical lens arrays are disposed like lattices. The optical axes of the blue-violet semiconductor lasers 12A and the ultraviolet semiconductor lasers 12B are disposed to cross the ridge lines of their own cylindrical lens arrays at right angles respectively.

Next, the operation of the fourth embodiment will be described.

The laser beams 1a output from the blue-violet semiconductor lasers 12A are formed as beams whose optical axes are parallel to one another, by the light source optical system 101A. The laser beams 1a are incident on the lens 120A. Then, the optical axes of the laser beams 1a are bent by the lens 120A so that the laser beams 1a are converged into an entrance end portion of the integrator 130. The laser beams 1a are transmitted through the wavelength selection beam splitter 110.

On the other hand, the laser beams 1b output from the blue-violet semiconductor lasers 12B are formed as beams whose optical axes are parallel to one another, by the light source optical system 101B. The laser beams 1b are incident on the lens 120B. Then, the optical axes of the laser beams 1b are bent by the lens 120B so that the laser beams 1b are converged into an entrance end portion of the integrator 130. The laser beams 1b are reflected by the wavelength selection beam splitter 110.

Then, the laser beams 1a and the laser beams 1b are coaxial with each other when they enter the integrator 130. The laser beams 1a and the laser beams 1b leaving the integrator 130 are transmitted through the lens 140 and reflected by the mirror 301. After that, the laser beams 1a and the laser beams 1b illuminate the DMD 200 with a uniform intensity distribution. Light reflected by the DMD 200 projects a pattern indicated in the DMD 200 onto a region 151 on the substrate 8 by the projection lens 301 subjected to color correction with respect to exposure light, so as to expose the region 151 with the projected pattern.

Also in the fourth embodiment, in the same manner as in the aforementioned embodiments, a desired pattern can be formed satisfactorily using a photosensitive agent when the intensity balance between the lights with the two wavelengths is optimized.

Also in the fourth embodiment, when infrared light is emitted from the other end portion 72 of the optical fiber 71, the exposure sensitivity can be improved substantially, so that the throughput can be improved.

It is preferable that a region to be irradiated with the infrared light emitted from the end portion 72 is set as a slightly wider area 152 than the exposure area 151.

The infrared light used in the third and fourth embodiments may be replaced by light with another wavelength if the photosensitive agent is not sensitive to the wavelength of the light.

In each embodiment, the number of kinds of wavelengths of lasers is set as two. However, the number of kinds of wavelengths of lasers may be increased.

The wavelengths of the lasers may be replaced by other wavelengths.

What is claimed is:

1. A pattern exposure method for moving outgoing beams emitted from light sources and a work relatively so as to expose a desired position of the work to the outgoing beams, the pattern exposure method comprising the steps of:
preparing a plurality of light sources emitting outgoing beams different in wavelength; and
turning on/off the light sources to thereby irradiate one and the same point of the work with a plurality of beams different in wavelength.

2. A pattern exposure method according to claim 1, wherein the light sources are semiconductor lasers.

3. A pattern exposure method according to claim 2, wherein one and the same point of the work is exposed by four or more different semiconductor lasers.

4. A pattern exposure method according to claim 1, wherein a point to be irradiated with the outgoing beams is irradiated with light whose wavelength should not expose the work, within several seconds before or after the point is irradiated with the outgoing beams.

5. A pattern exposure apparatus comprising:
at least two color light sources emitting lights different in wavelength;
an optical system for projecting outgoing beams emitted from the light sources on a work;
a switching means for turning on/off the light sources;
a moving means for moving projected spots and the work relatively; and
a control means for controlling the relative movement of the projected spots and the work and the on/off switching of the light sources synchronously with each other.

6. A pattern exposure apparatus according to claim 5, further comprising:
a light source emitting light whose wavelength cannot expose the work.
